(19) United States
(12) Patent Application Publication
(10) Pub. No.: US 2013/0339082 A1
(43) Pub. Date: Dec. 19, 2013

(54) CONTEXTUAL INFORMATION RETRIEVAL FOR GROUPWARE INTEGRATION

(71) Applicants: Gerrit Simon KAZMAIER, Heidelberg (DE); Timo HOYER, San Francisco, CA (US); Ulrich BESTFLEISCH, Schwetzingen (DE)

(72) Inventors: Gerrit Simon KAZMAIER, Heidelberg (DE); Timo HOYER, San Francisco, CA (US); Ulrich BESTFLEISCH, Schwetzingen (DE)

(73) Assignee: SAP AG, Walldorf (DE)

(21) Appl. No.: 13/495,709

(22) Filed: Jun. 13, 2012

(51) Int. Cl. G06Q 30/02

(52) U.S. Cl. 705/7.29

(57) ABSTRACT

A groupware application may be modified to include additional functionality enabling data from the groupware application to be exchanged with customer account data in a customer relationship management (CRM) system. After selecting a message or meeting object, a third party email address included in the object may be identified and sent to the CRM system. Account information relating to an account in the CRM system associated with the email address may be retrieved and sent to the groupware application. This additional account information may include marketing leads and/or opportunities, which may be displayed in the groupware application. The user may select a lead and/or an opportunity to associate the user selected object with the user selected lead and/or opportunity. This information may be sent to CRM system. Other information relating to the user selected object may also be sent to the CRM system.

### BACKGROUND

Many business entities use customer relationship management (CRM) systems to manage customer interactions. These systems may be capable of organizing and tracking sales, marketing, customer service, and other related activities. While CRM systems may be used by the organization to track these activities, employees often conduct additional activities through other applications external to CRM systems.

For example, users may use groupware applications, such as messaging and/or calendaring programs to send emails and/or other messages to clients. User may also use groupware applications to schedule meetings, keep track of appointments, and manage other customer related tasks. While this customer related data has been previously exported from groupware applications into a CRM system in order to ensure that the data in the CRM system is up-to-date and complete, these existing data exporting techniques required full synchronization between the contact data in the groupware application and that in CRM system. This has prevented the technique from being used in more restrictive environments, such as mobile devices, where a full or manual synchronization is impractical and cumbersome.

There is a need for an ad hoc integration of groupware application data with CRM system data without the need for contact synchronization.

### BRIEF DESCRIPTION OF THE DRAWINGS

FIG. 1 shows an exemplary process in an embodiment.

FIG. 2 shows an exemplary view of a calendar functionality in a modified groupware application.

FIG. 3 shows an exemplary view of email functionality in a modified groupware application

FIG. 4 shows an exemplary flow of data between applications and systems.

FIG. 5 shows an exemplary architecture in an embodiment.

### DETAILED DESCRIPTION

A groupware application may be modified to include additional functionality enabling data from the groupware application to be exchanged with customer account data in a customer relationship management (CRM) system. Gadgets, add-ins, application programming interfaces (APIs), and other tools may be used to modify the groupware application. The additional functionality may be enabled when a user selects a message or meeting object in the groupware application that includes at least one third party email address. The message or meeting object may include an email message, a meeting request, an appointment, an instant message, a short messaging service (SMS) message, or a text-based post.

Once the user selects an object in the groupware application, a third party email address included in the object may be identified and sent to the CRM system. In some instances, data exchanges between a groupware application system and the CRM system may occur using a representational state transfer (REST) or other stateless architecture. In other instances, a stateful protocol may be used.

Once the identified third party email address is received at the CRM system, the CRM system may lookup the customer account stored in the CRM system that is associated with the received email address. This may occur by matching the third party email address in the object to a corresponding email address of an account in the CRM system.

In some instances, more than one email address may be identified and sent to the CRM system. This may occur if there are multiple recipients or invitees in the groupware application object. The CRM system may also identify more than one account that is associated with the received email address or addresses. If more than one account is identified, a list of accounts may be generated and sent to the groupware application, where they may be presented to the user for the user to select the account that is to be associated with the object. Once the user makes a selection, the account selection may be sent back to the CRM system.

Once a single customer account has been identified, additional account information relating to the single account may be retrieved from the CRM system and sent to the groupware application. This additional account information may include marketing leads and/or opportunities for a sales representative or other employee to discuss with the person having the identified email address. The additional account information may also include additional contact information for other contacts associated with the identified account.

The additional account information may be sent to the groupware application and displayed in a separate area of the groupware application allocated for this purpose. A user may interact with the displayed additional account information. For example, the user may select the additional contact information to initiate contact with other contacts associated with the account. The user may select a lead and/or an opportunity displayed as part of the additional account information in order to associate the object in the groupware application selected by the user with the user selected lead and/or opportunity. This association may be stored in the groupware.

The association and/or data from the selected groupware application object may be sent from the groupware application to the CRM system to associate the groupware object with the selected lead and/or opportunity in the CRM system. This association may later be used to identify specific actions taken with respect to different leads and/or opportunities. For example, reports may be later generated showing each meeting, email, and/or other actions taken by one or more employees to follow-up on and/or pursue one or more leads.

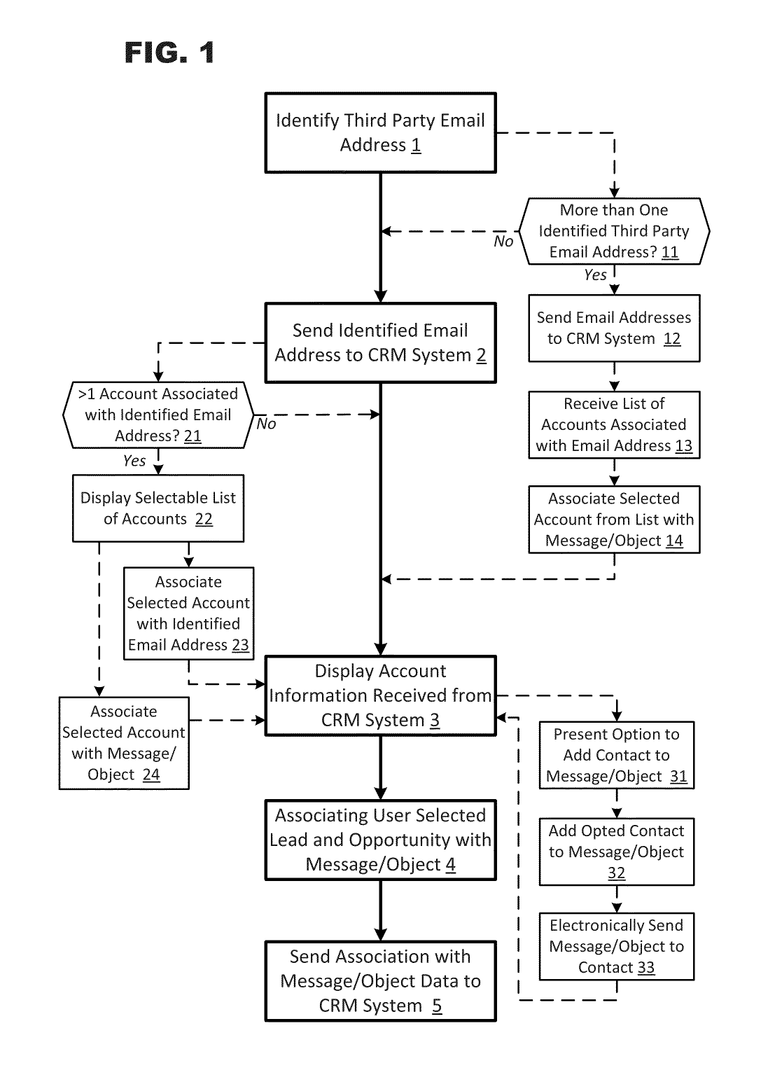

FIG. 1 shows an exemplary process for associating business information in a groupware application with data in a customer relationship management system. The process may be performed by a processing device. In some instances, the process may be stored in instructions encoded in a non-transitory computer readable medium, that when executed by the processing device, cause the processing device to perform the process.

In box 1, a third party email address in a user selected message or meeting object of the groupware application may be identified. The third party email address may be an email address of someone other than the user of the groupware application and/or an email address of a customer of the user of the groupware application. The third party email address may be identified by parsing or scanning the object for content resembling an email address and/or searching one or more specific fields known to contain email addresses.

The meeting object may be an appointment stored in a calendar of the groupware application or a meeting stored in the groupware application. The message may be an email message, instant message, a short messaging service (SMS) message, a text-based post, or other type of message. The third party email address may be an email address of a customer of a groupware application user.

In box 2, the groupware application may send the identified email address to the CRM system over a communications network. Once the CRM received the email address, the CRM system may identify an account having an email address associated with the identified email address. The account information of the identified account may be transmitted back to the groupware application over the communications network.

In box 3, responsive to the groupware application receiving the account information from the CRM system, the received account information may be displayed in the groupware application. The displayed account information may include contact information of at least one person associated with the account. The displayed account information may also include two or more selectable marketing leads for engaging an account holder and opportunities for selling specific products to the account holder. The marketing leads may include an open topic to be discussed with a customer. The opportunities may include a product or service identifier of a respective product or service pertaining to the account.

In box 4, a user selected lead and a user selected opportunity from the displayed account information may be associated with the user selected message or meeting object in the groupware application. An open topic of user selected lead may correspond to a subject of the user selected message or meeting object. A product or service identifier of the user selected opportunity may correspond to a subject of the user selected message or meeting object.

In box 5, the association in box 4 may be sent with a copy of data from the user selected message or meeting object to the CRM system to associate the copy of the data with the user selected lead and the user selected opportunity in the customer relationship management system. The copy of data from the user selected message or meeting object sent to the customer relationship management system may include a subset of content included in the user selected message with a link to the user selected message and/or an entire content of the user selected message. The association and the copy of data from the user selected message or meeting object sent to the customer relationship management system may be used to generate a report of marketing activity, which may include a reference to the user selected message or meeting object.

Boxes 11 to 14, 21 to 24, and 31 to 33 relate to additional processes that may be performed in different embodiments. These additional processes may be performed in conjunction with the process in boxes 1 to 5. For example, after identifying at least one third party email address in a user selected message or meeting object of the groupware application in box 1, a determination may be made in box 11 whether user selected message or meeting object contains more than one third party email address.

If the user selected message or meeting object does not contain more than one third party email address, the process may go to box 2. If the user selected message or meeting object contains more than one third party email address, the process may go to box 12.

In box 12, each of the identified third party email addresses in the user selected message or meeting object of the groupware application may be sent to the CRM system over the communications network. The CRM system may then identify those accounts associated with each of the identified third party email addresses, and sent a list of the identified accounts to the system executing the groupware application.

In box 13, the system executing the groupware application may receive the list of accounts from the customer relationship management system. The groupware application may display the list of accounts in a user interface from which a user may select one of the accounts.

In box 14, responsive to the user selecting one of the accounts in the list, the selected account may be associated with the user selected message or meeting object in the groupware application and the process may proceed to box 3. If the user selected message or meeting object is later reselected by the user, the associated may be recalled in order to display the account information of the selected account in the groupware application without having to repeat the account selection process.

In a second additional process, after sending the identified email address to the CRM system in box 2, in box 21 a determination may be made as to whether the identified email address sent to the CRM system is associated with more than one account. If only one account is associated with the identified email address, the process may to go box 3.

If, however, more than one account is associated with the identified third party email address, then in box 22, a list of each account associated with the identified third party email address that is received from the customer relationship management system may be displayed in the groupware application. The list of each account associated with the identified third party email address may be sent to the groupware application from the CRM system.

In box 23, a user selected account from the selectable account list may be associated with the identified third party email address. This association of the user selected account with the identified third party email address may be sent to the CRM system. The association may be used in the future to only send account information of the user selected account specified in the association to the groupware application each time the CRM system receives the identified third party email address.

In box 24, a user selected account from the selectable account list may be associated with the user selected message or meeting object in the groupware application. This association may be recalled in the future in response to the user selecting the user selected message or meeting object. The association may be used to retrieve and display the account information of the associated user selected account in the groupware application.

In a third additional process, in box 31, the user may be presented with an option to add a contact email address included the account information received from the CRM system in box 3 to the user selected message or meeting object. This option may include, but is not limited to, a clickable object, button, or text corresponding to the contact email address that is displayed in the groupware application as part of the account information received from the CRM system.

In box 32, responsive to the user selecting the option in box 31, the contact email address may be added to the user selected message or meeting object of the groupware application.

In box 33, the user selected message or meeting object may be sent to the contact email address added in box 32. The contact email address added in box 32 may be henceforth associated with the user selected message or meeting object.

The process in boxes 31 to 33 may be performed in response to the displayed contact information of at least one person associated with the account including a contact email address that was not included in the user selected message or meeting object of the groupware application.

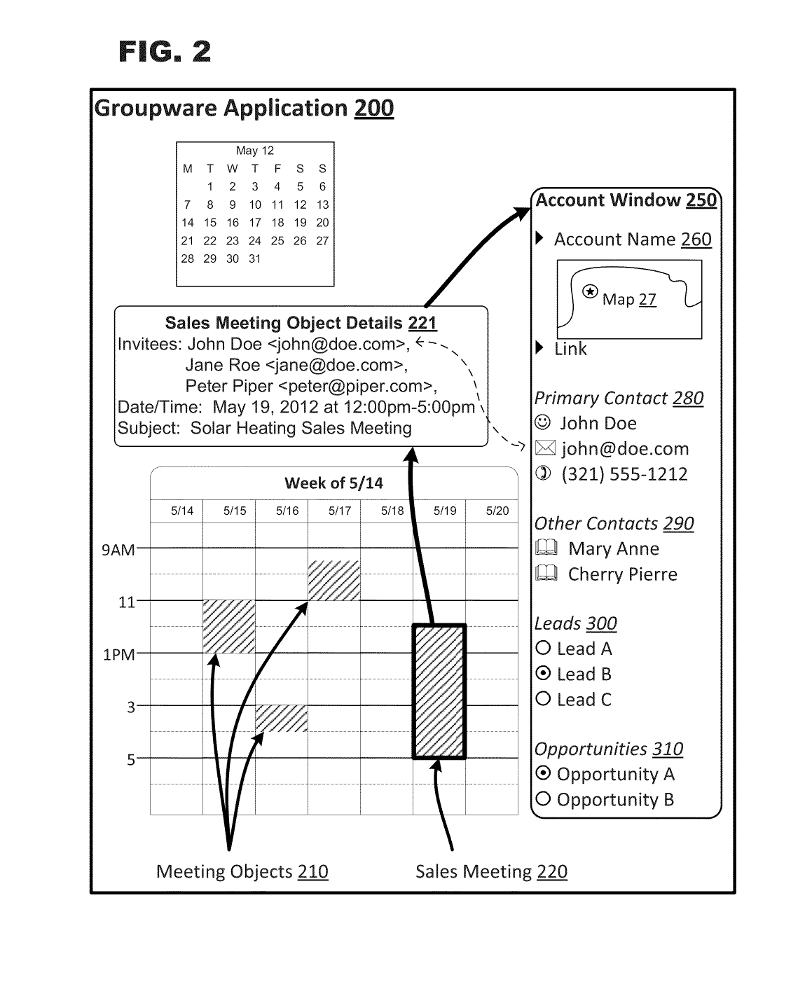

FIG. 2 shows an exemplary view of a calendar functionality in a groupware application 200 modified to display additional account information from a CRM system. The groupware application may be modified through the use of add-ins, gadgets, and other tools in different groupware applications. Several meeting objects 210 and 220 are shown in a timeline for the week of May 14. These meeting objects 210 and 220 may represent appointments, meetings, events, or other activities that may involve one or more third parties. A user may select a object 210 and 220 by clicking or otherwise activating the object 210 and 220 in the timeline. For example, the user may select the sales meeting object 220 in the timeline corresponding to a meeting occurring between 12 pm and 5 pm on May 19. The details 221 of the sales meeting object 220 may show the invitees to the meeting, the email addresses of the meeting invitees, a date and time of the meeting, and a subject of the meeting. Other information, such as a location, speaker, and agenda may be included in some meeting objects 210 and 220.

In response to the user selecting the sales meeting object 221, the third party email addresses john@doe.com and jane@doe.com in the sales meeting object 221 may be identified and sent to the CRM system. The CRM system may determine that there is only one account associated with the email address john@doe.com and the CRM system may send the account information of the one account back to the groupware application. The groupware application may display the account information from the CRM system in the account window 250.

The displayed account information may include an account name 260, a map 27 showing a location associated with the account, a link to additional information about the account, primary contact information 280, other contact information 290, one or more leads 300 associated with the account, and one or more opportunities 310 associated with the account. The contact information may include an email address, a phone number, a name, or other contact information for one or more persons. The leads 300 and opportunities 310 may include one or more open marketing leads and opportunities associated with the account in the CRM system.

A user may make a lead selection and an opportunity selection from the leads 300 and opportunities 310 displayed in the account window 250. The lead and opportunity selection may be sent back to the CRM system with data about the user selected sales meeting object 220, which may include information included in details 221. One or more of the contacts 280 and/or 290 may also be selected from the account window 250 in order to add the contact to the meeting object 220 and/or send the meeting object to the contact. The meeting object may be sent to the contact in order to formally invite the contact to join the meeting or for another purpose.

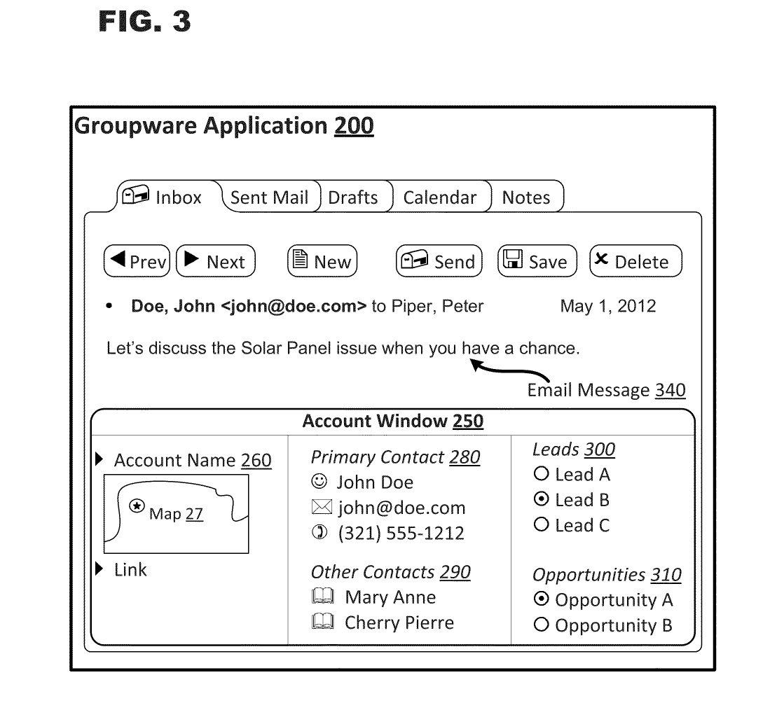

FIG. 3 shows an exemplary view of email functionality in a groupware application 200 modified to display additional account information from the CRM system. The groupware application may be modified through the use of add-ins, gadgets, and other tools in different groupware applications. An exemplary email message 340 from John Doe to Peter Piper received on May 1, 2012 is shown in an interface of the groupware application 200. A user may have selected or otherwise navigated to this particular message 340.

In response to the user selecting or viewing the email message 340, the third party email address of John Doe in the email message 340 may be identified and sent to the CRM system. The CRM system may determine that there is only one account associated with John Doe's email address and the CRM system may send the account information of the one account back to the groupware application. The groupware application 200 may display the account information from the CRM system in the account window 250 positioned below the email message 340.

The displayed account information may include an account name 260, a map 27 showing a location associated with the account, a link to additional information about the account, primary contact information 280, other contact information 290, one or more leads 300 associated with the account, and one or more opportunities 310 associated with the account. The contact information may include an email address, a phone number, a name, or other contact information for one or more persons. The leads 300 and opportunities 310 may include one or more open marketing leads and opportunities associated with he account in the CRM system.

A user may make a lead selection and an opportunity selection from the leads 300 and opportunities 310 displayed in the account window 250. The lead and opportunity selection may be sent back to the CRM system with data relating to the email message 340. One or more of the contacts 280 and/or 290 may also be selected from the account window 250 in order to add the contact to the email message 340 and/or send a copy of the email message 340 to the contact.

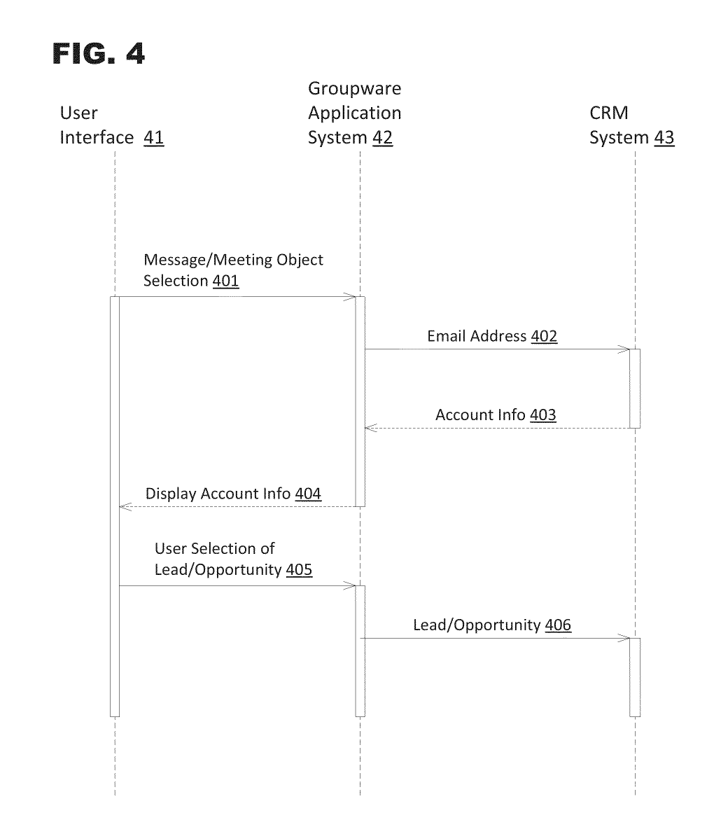

FIG. 4 shows an exemplary flow of data between applications and systems. Initially, a user may make a message or meeting object selection 401 from a user interface 41 of the groupware application 200 running on the groupware application system 42. Once the groupware application system 42 processes the object selection 401, the groupware application system 42 may analyze the selected message or meeting object and identify a third party email address in the object.

The groupware application system 42 may then send the identified third party email address 402 to the CRM system 43. The CRM system 43 may compare the email address to customer account records and identify an account with a corresponding email address. The CRM system 43 may then retrieve the account information of this identified account and send the account information back to the groupware application system 42. The groupware application system 42 may then send the account information to the user interface 41 where it is presented to the user.

The account information presented to the user may include one or more selectable leads and/or opportunities. Once the user makes a lead and/or opportunity selection 405, the groupware application system 42 may process the selection 450 and send the selection to the CRM system 43.

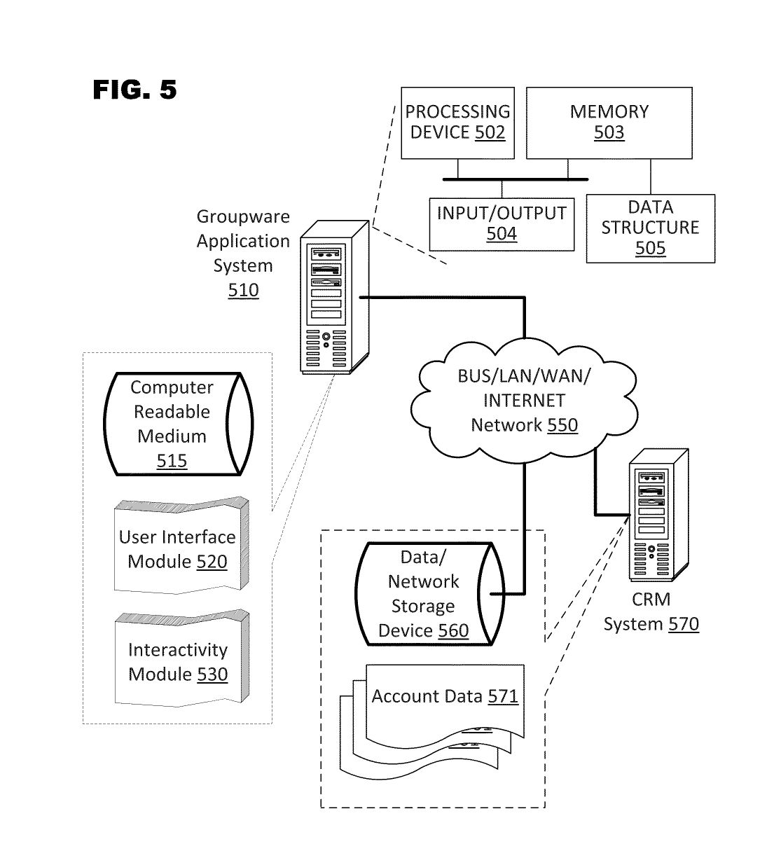

FIG. 5 shows an exemplary architecture. Groupware application system 510 may include a computer readable medium 515 storing application modules that may include a user interface module 520 and/or an interactivity module 530 enabling interactivity in the groupware application system between the groupware application and the CRM system 570. In some instances, these modules 520 and 530, and/or other modules or components of the groupware application system 510 may be stored in a memory 503 or data structure 505 that is separate from the computer readable medium 515 and/or the groupware application system 510.

The user interface module 520 may be adapted to enable a user to select a message or meeting object in a groupware application, display account information in the groupware application, and enable a user to select a lead and an opportunity from the displayed account information.

The interactivity module 530 may be adapted to identify a third party email address in the user selected message or meeting object from the user interface module 520 and send the identified email address to the communications device 504 for transmission to the customer relationship management system 570 over the communications network 550.

The interactivity module 530 may also be adapted to receive account information 571 from the CRM system 570, and in response to receiving the account information 571 of an account associated with the identified email address from the communications device 504, may send the account information 571 to the user module 520. The account information 571 may include contact information of at least one person associated with the account and a plurality of selectable marketing leads for engaging an account holder and opportunities for selling specific products to the account holder.

The interactivity module 530 may also be adapted to associate a user selected lead and a user selected opportunity from the user interface module 520 with the user selected message or meeting object in the groupware application.

The interactivity module 530 may also be adapted to send the association with a copy of data from the user selected message or meeting object to the communications device 504 for transmission to the CRM system 570 to associate with the data with the user selected lead and the user selected opportunity in the CRM system 570.

The interactivity module 530 may also be adapted to identify a plurality of third party email addresses in the user selected message or meeting object of the groupware application and send each of the identified email address to the CRM system 570 over the communications network 550.

The interactivity module 530 may also be adapted to receive a list of accounts associated with the sent email addresses from the CRM system 570.

In response to a user selection of an account in the list, the interactivity module 530 may also be adapted to associate the selected account with the user selected message or meeting object in the groupware application for a future selection of said message or meeting object, wherein the account information of the selected account is displayed in the groupware application.

The interactivity module 530 may also be adapted to, in response to the CRM system 570 associating more than one account with the identified third party email address, display a list of each account associated with the identified third party email address that is received from the CRM system 570. The interactivity module 530 may also be adapted to, in response to a user selection of an account in the list, associate the user selected account with the user selected message or meeting object in the groupware application, wherein in response to a future selection of the user selected message or meeting object, the account information of the associated user selected account is displayed in the groupware application.

Groupware application system 510 and CRM system 570 may be connected to a network 550. Network 550 may include a LAN, WAN, bus, or the Internet. Groupware application system 510 and/or CRM system 570 may interface with other systems and components depending on the application. For example, a network/data storage device 560 may be used to store account data 571 of the CRM system 570. The storage device 560 may be a part of the CRM system 570.

In some embodiments the network storage device 560 may also be separate from the CRM system 570 but connected to it through network 550. The storage device 560 may contain a hard disk drive, flash memory, or other computer readable media capable of storing data. Other external systems and data sources may also be connected to network 550. These other systems may be used to supply additional data or information used by the groupware application system 510 or the CRM system 570, such as, for example, customer, messaging, account, or other organizational data.

Each of the systems, clients, and devices in FIG. 5 may contain a processing device 502, memory 503 storing loaded data or a loaded data structure 505, and a communications device 504, all of which may be interconnected via a system bus. In various embodiments, each of the systems 510 and 570 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

Communications device 504 may enable connectivity between the processing devices 502 in each of the systems 510 and 570 and the network 550 by encoding data to be sent from the processing device 502 to another system over the network 550 and decoding data received from another system over the network 550 for the processing device 502.

In an embodiment, memory 503 may contain different components for retrieving, presenting, changing, and saving data and may include the computer readable medium 515. Memory 503 may include a variety of memory devices, for example, Dynamic Random Access Memory (DRAM), Static RAM (SRAM), flash memory, cache memory, and other memory devices. Additionally, for example, memory 503 and processing device(s) 502 may be distributed across several different computers that collectively comprise a system.

Processing device 502 may perform computation and control functions of a system and comprises a suitable central processing unit (CPU). Processing device 502 may include a single integrated circuit, such as a microprocessing device, or may include any suitable number of integrated circuit devices and/or circuit boards working in cooperation to accomplish the functions of a processing device. Processing device 502 may execute computer programs, such as object-oriented computer programs, within memory 503.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, although the groupware application system 510 is shown as a separate system from the CRM system 570, in some instances the groupware application system 510 and the CRM system 570 may be functionally integrated into a single system.

1. A method for associating business information in a groupware application with data in a customer relationship management system comprising:
identifying a third party email address in a user selected message or meeting object of the groupware application;
sending the identified email address to the customer relationship management system over a communications network;
responsive to receiving account information of an account associated with the identified email address from the customer relationship management system, displaying the account information in the groupware application, the account information including contact information of at least one person associated with the account and a plurality of selectable marketing leads for engaging an account holder and opportunities for selling specific products to the account holder;
associating, using a processing device, a user selected lead and a user selected opportunity from the displayed account information with the user selected message or meeting object in the groupware application; and
sending the association with a copy of at least some content from the user selected message or meeting object to the customer relationship management system to associate the content with the user selected lead and the user selected opportunity in the customer relationship management system, wherein the customer relationship management system generates a report including the copy of the content from each message and meeting following up on at least one of the leads or the opportunities based on the association and the copy of the content sent to the customer relationship management system.

2. The method of claim 1, further comprising:
identifying a plurality of third party email addresses in the user selected message or meeting object of the groupware application;
sending each of the identified email address to the customer relationship management system over the communications network;
receiving a list of accounts associated with the sent email addresses from the customer relationship management system; and
responsive to a user selection of an account in the list, associating the selected account with the user selected message or meeting object in the groupware application for a future selection of said message or meeting object, wherein the account information of the selected account is displayed in the groupware application.

3. The method of claim 1, further comprising, responsive to the customer relationship management system associating more than one account with the identified third party email address:
displaying a list of each account associated with the identified third party email address that is received from the customer relationship management system;
responsive to a user selection of an account in the list, associating the user selected account with the user selected message or meeting object in the groupware application, wherein responsive to a future selection of the user selected message or meeting object, the account information of the associated user selected account is displayed in the groupware application.

4. The method of claim 1, further comprising, responsive to the customer relationship management system associating more than one account with the identified third party email address:
displaying a list of each account associated with the identified third party email address that is received from the customer relationship management system;
responsive to a user selection of an account in the list, associating the user selected account with the identified third party email address; and
sending the association of the user selected account with the identified third party email address to the customer relationship management system, wherein responsive to a future sending of the identified third party email address to the customer relationship management system, only account information of the user selected account in the association is received from the customer relationship management system.

5. The method of claim 1, further comprising, responsive to the displayed contact information of at least one person associated with the account including a contact email address that was not included in the user selected message or meeting object of the groupware application:
presenting a user with an option to add the contact email address to the user selected message or meeting object; and
responsive to the user selecting the option, adding the contact email address to the user selected message or meeting object of the groupware application and send the user selected message or meeting object to the contact email address.

6. The method of claim 1, wherein the meeting object is an appointment stored in a calendar of the groupware application.

7. The method of claim 1, wherein the meeting object is a meeting stored in the groupware application.

8. The method of claim 1, wherein the message is an email message.

9. The method of claim 1, wherein the message is one of an instant message, a short messaging service (SMS) message, or a text-base post.

10. The method of claim 1, wherein the third party email address is an email address of a customer of a groupware application user.

11. The method of claim 1, wherein the copy of content from the user selected message or meeting object sent to the customer relationship management system includes a subset of content included in the user selected message with a link to the user selected message.

12. The method of claim 1, wherein the copy of content from the user selected message or meeting object sent to the customer relationship management system includes an entire content of the user selected message.

13. The method of claim 1, wherein each of the user selected leads includes an open topic to be discussed with a customer of the account and the open topic of the user selected lead corresponds to a subject of the user selected message or meeting object.

14. The method of claim 1, wherein each of the opportunities include a product or service identifier of a respective product or service pertaining to the account and the product or service identifier of the user selected opportunity corresponds to a subject of the user selected message or meeting object.

15. The method of claim 1, wherein the association and the copy of content from the user selected message or meeting object sent to the customer relationship management system is used to generate a report of marketing activity.

16. The method of claim 15, wherein the report includes a reference to the user selected message or meeting object.

17. A non-transitory computer readable medium comprising stored instructions, that when executed by a processing device, cause the processing device to:
identify a third party email address in a user selected message or meeting object of a groupware application;
send the identified email address to a customer relationship management system over a communications network;
responsive to receiving account information of an account associated with the identified email address from the customer relationship management system, display the account information in the groupware application, the account information including contact information of at least one person associated with the account and a plurality of selectable marketing leads for engaging an account holder and opportunities for selling specific products to the account holder;
associate, using a processing device, a user selected lead and a user selected opportunity from the displayed account information with the user selected message or meeting object in the groupware application; and
send the association with a copy of at least some content from the user selected message or meeting object to the customer relationship management system to associate with the content with the user selected lead and the user selected opportunity in the customer relationship management system, wherein the customer relationship management system generates a report including the copy of the content from each message and meeting following up on at least one of the leads or the opportunities based on the association and the copy of the content sent to the customer relationship management system.

18. The non-transitory computer readable medium of claim 17, wherein
each of the marketing leads includes an open topic to be discussed with a customer of the account,
the open topic of the user selected lead corresponds to a subject of the user selected message or meeting object,
each of the opportunities include a product or service identifier of a respective product or service pertaining to the account,
the product or service identifier of the user selected opportunity corresponds to the subject of the user selected message or message object,
the association and the copy of content from the user selected message or meeting object sent to the customer relationship management system is used to generate a report of marketing activity, and
the report includes a reference to the user selected message or meeting object.

19. A system comprising:
a communication device connected to a communications network; and
a processing device;
a user interface module adapted to:
enable a user to select a message or meeting object in a groupware application;
display account information in the groupware application; and
enable a user to select a lead and an opportunity from the displayed account information; and
an interactivity module adapted to:
identify a third party email address in the user selected message or meeting object from the user interface module;
send the identified email address to the communications device for transmission to a customer relationship management system over the communications network;
responsive to receiving account information of an account associated with the identified email address from the communications device, send the account information to the user interface module, the account information including contact information of at least one person associated with the account and a plurality of selectable marketing leads for engaging an account holder and opportunities for selling specific products to the account holder;
associate a user selected lead and a user selected opportunity from the user interface module with the user selected message or meeting object in the groupware application; and
send the association with a copy of at least some content from the user selected message or meeting object to the communications device for transmission to the customer relationship management system to associate with the content with the user selected lead and the user selected opportunity in the customer relationship management system, wherein the customer relationship management system generates a report including the copy of the content from each message and meeting following up on at least one of the leads or the opportunities based on the association and the copy of the content sent to the customer relationship management system.

20. The system of claim 19, wherein the interactivity module is further adapted to:
identify a plurality of third party email addresses in the user selected message or meeting object of the groupware application;
send each of the identified email address to the customer relationship management system over the communications network;
receive a list of accounts associated with the sent email addresses from the customer relationship management system;
responsive to a user selection of an account in the list, associate the selected account with the user selected message or meeting object in the groupware application for a future selection of said message or meeting object, wherein the account information of the selected account is displayed in the groupware application; and
responsive to the customer relationship management system associating more than one account with the identified third party email address:
display a list of each account associated with the identified third party email address that is received from the customer relationship management system; and
responsive to a user selection of an account in the list, associate the user selected account with the user selected message or meeting object in the groupware application, wherein responsive to a future selection of the user selected message or meeting object, the account information of the associated user selected account is displayed in the groupware application.
